(19) United States
(12) Patent Application Publication
(10) Pub. No.: US 2002/0049045 A1
(43) Pub. Date: Apr. 25, 2002

(54) Circuit arrangement

(76) Inventors: De Zeeuw Stephan, Hamburg (DE); Juergen Nowottnick, Hamburg (DE)

Correspondence Address: U.S. Philips Corporation, 580 White Plains Road, Tarrytown, NY, 10591, US

(21) Appl. No.: 09/933,783

(22) Filed: Aug. 21, 2001

(30) Foreign Application Priority Data
Aug. 22, 2000 (DE) 10041008.1

(51) Int. Cl. H04B 1/18

(52) U.S. Cl. 455/180.2; 455/180.1

(57) ABSTRACT

To provide a circuit arrangement for converting a preferably analog input signal from at least a receiver, particularly at least a UHF or VHF receiver, into a digital output signal, said circuit arrangement (100) comprising:

at least one threshold value circuit (30) having a first input (32) for receiving the input signal;

a second input (34) for receiving a reference threshold signal generated by at least one reference threshold signal detector (20); and an output (36),

the digital output signal being formed in the threshold value circuit (30) by comparing the input signal at the first input (32) with the reference threshold signal at the second input (34);

at least one detector circuit (40) arranged subsequent to and communicating with the threshold value circuit (30) for detecting overshoots and/or pauses and/or interruptions in the input signal; and

at least one control circuit (50) communicating with the detector circuit (40) and the reference threshold signal detector (20), the output signal of said control circuit ensuring that the reference threshold signal applied to the threshold value circuit (30) during time intervals (Tₐᵤₛ) that are assignable to the overshoots and/or the pauses and/or the interruptions detected by the detector circuit (40) is maintained at approximately the reference threshold value comprising the reference threshold signal at the start of the overshoot and/or the pause and/or the interruption,

by which pulse width distortions are reduced and losses of single bits, particularly at the start of a data packet, are obviated, and by which digital noise at the data output is prevented, it is proposed that

the reference threshold signal detector (20) forms the reference threshold signal from the input signal and comprises at least a resistor (22) having a variable resistance value (R) and at least a capacitive element (24) having a capacitance (C) arranged subsequent to the resistor (22), and that

the resistor (22) assumes a high-ohmic state preventing a discharge of the capacitive element (24) during the time intervals (Tₐᵤₛ) that are assignable to the overshoots and/or the pauses and/or the interruptions, and a low-ohmic state during the time intervals that are not assignable to the overshoots and/or the pauses and/or the interruptions.

The invention relates to a circuit arrangement for converting a preferably analog input signal from at least a receiver, particularly at least a UHF or VHF receiver, into a digital output signal, said circuit arrangement comprising:

at least one threshold value circuit having a first input for receiving the input signal;

a second input for receiving a reference threshold signal generated by at least one reference threshold signal detector; and an output,

the digital output signal being formed in the threshold value circuit by comparing the input signal at the first input with the reference threshold signal at the second input;

at least one detector circuit arranged subsequent to and communicating with the threshold value circuit for detecting overshoots and/or pauses and/or interruptions in the input signal; and

at least one control circuit communicating with the detector circuit and the reference threshold signal detector, the output signal of said control circuit ensuring that the reference threshold signal applied to the threshold value circuit during time intervals that are assignable to the overshoots and/or the pauses and/or the interruptions detected by the detector circuit is maintained at approximately the reference threshold value comprising the reference threshold signal at the start of the overshoot and/or the pause and/or the interruption.

Such a circuit arrangement is known from DE 32 40 853 C2. This document describes a circuit in which an information signal read by a record carrier is converted, i.e. digitized into a square-wave output signal by means of a threshold value circuit. Such information signals sometimes have unwanted overshoots which have a more than disturbing influence on the digitized output signal. To compensate the disturbing influence of such overshoots, the known circuit comprises a detector circuit and a control circuit whose cooperation during time intervals that are assignable to the overshoots detected by the detector circuit ensures that the reference threshold signal applied to the threshold value circuit is approximately maintained at the reference threshold value which the reference threshold signal had at the start of the overshoot.

It is true that DE 32 40 853 C2 gives useful suggestions for solving the question of how such overshoots in the incoming information signal can be literally “bridged”, i.e. compensated, but the practical realization of the known circuit arrangement has proved that this is too much for processing single data packets, particularly when used in current digital radio transmission systems such as, for example UHF or VHF radio data systems such as alarm systems, opening systems for garage doors, heating control systems, radio systems for vehicles (PKE=passive keyless entry, RKE=remote keyless entry), particularly when such single data packets, based on systems, are separated by comparatively large temporal distances.

For example, the known circuit arrangement is only constituted for central reading methods based on a continuous data stream of stored data and consequently only for sporadic unwanted overshoots in the incoming information signal, but it is not constituted for temporal pauses and interruptions between the individual data packets, which pauses and interruptions are required and thus wanted for radio data transmission. Moreover, the known circuit has the drawback that the reference threshold signal is gained from the output signal which has already been digitized, i.e. the known circuit is implemented in the form of a control circuit so that a decentral arrangement of the known circuit can only be realized—if at all—with a disproportionately large number of components.

It is an object of the invention to provide a circuit arrangement of the type described in the opening paragraph which can be decentrally formed so that different elements of the circuit arrangement may also be arranged on different components or even on different integrated circuits or on different microcircuits; furthermore, the envisaged circuit arrangement should ensure that pulse width distortions are reduced and losses of single bits, particularly at the start of a data packet, are obviated, and digital noise at the data output is prevented.

This object is solved by the characteristic features as defined in claim 1. Advantageous embodiments and essential improvements of the present invention are defined in the dependent claims.

In accordance with the teaching of the present invention, the reference threshold signal detector comprises at least a resistor having a variable resistance value R and at least a capacitive element having a capacitance C arranged subsequent to the resistor, which resistor assumes a high-ohmic state preventing a discharge of the capacitive element during the time intervals that are assignable to the overshoots and/or the pauses and/or the interruptions, and a low-ohmic state during the time intervals that are not assignable to the overshoots and/or the pauses and/or the interruptions.

In other words, this means that a kind of “track-and-hold” circuit arrangement is realized in the present invention. During the transmission of data (=in time intervals that are not assignable to the overshoots and/or the pauses and/or the interruptions), in which the resistor is in the low-ohmic state, there is a low-ohmic connection to the capacitive element so that the threshold level of the reference threshold signal effectively adapts to the level of the input signal (“track” mode) in which mode the input signal is preferably present in the form of a low-frequency analog baseband signal converted in the receiver.

However, between the single data packets (=the time intervals that are assignable to the overshoots and/or the pauses and/or the interruptions), the level of the reference threshold signal is fixed in that the resistor is in the high-ohmic state, which actually means that the connection to the capacitive element is separated (“hold” mode) so that the capacitive element is prevented from being discharged on the basis of the missing baseband signal during the time intervals that are assignable to the overshoots and/or the pauses and/or the interruptions, which would lead to changed pulse widths or even missing bits at the start of each data packet.

For the reasons mentioned hereinbefore, the time constant τ=R·C of the reference threshold signal detector resulting as the product of the resistance R and the capacitance C must be chosen to be very large in conventional circuit arrangements as disclosed in, for example, DE 32 40 853 C2, which leads to a long build-up time of the receiver.

In receivers with conventional circuit arrangements and without additional fixed reference values, which are adjustable particularly by means of an additional resistor at the second input of the threshold value circuit, the discharge of the capacitive element further leads to digital noise at the data output. Under circumstances, this accidental and unwanted digital noise signal is interpreted as a correct signal by a subsequent controller and violates the digital data protocol. An additional, fixed reference value at the threshold value circuit would, however, still affect the sensitivity of the receiver and thus the range of the radio transmission system.

With respect to the teaching of the present invention, those skilled in the art will appreciate that the reference threshold signal detector forms the reference threshold signal from the input signal, i.e. preferably from the low-frequency analog baseband signal converted in the receiver. Consequently, the time lengths of the “track-and-hold” modi can be adapted advantageously to the data and transmission protocol used in the relevant application. It should be noted that in accordance with a further advantageous embodiment of the present invention, the threshold value circuit is constituted by a comparator whose first input is positive and whose second input is negative, which is not the case in the circuit arrangement disclosed in DE 32 40 853 C2.

The invention also relates to a receiver, particularly a UHF or VHF receiver comprising at least a subsequent circuit arrangement of the type described hereinbefore.

These and other aspects of the invention are apparent from and will be elucidated with reference to the embodiments described hereinafter.

In the drawing:

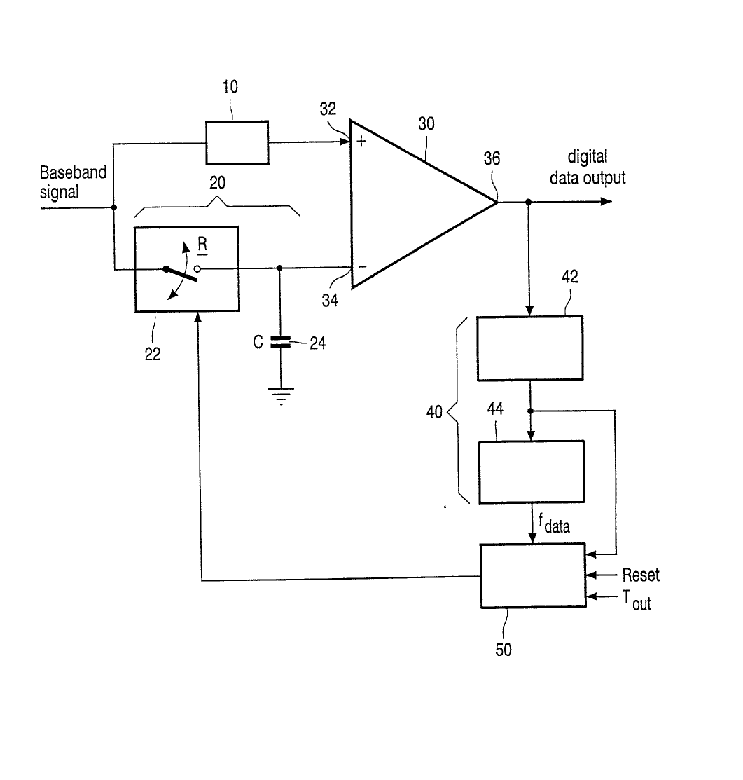

FIG. 1 shows diagrammatically an embodiment of a circuit arrangement according to the present invention.

The circuit arrangement 100 is provided for converting an analog input signal from an UHF or VHF receiver into a digital output signal and is characterized in that, if necessary, it can be spread over a plurality of components (for example, a receiver with integrated switches and control by means of connected controllers).

The circuit arrangement 100 comprises a threshold value circuit 30, constituted as a comparator, with a positive first input 32 for receiving the input signal, a negative second input 34 for receiving a reference threshold signal generated by a reference threshold signal detector 20, and an output 36. The input signal is applied in the form of a low-frequency analog baseband signal converted in the receiver to the first input 32 of the threshold value circuit 30 after it has been filtered in a filter stage 10 preceding the first input 32 of the threshold value circuit 30.

The reference threshold signal detector 20 comprises an RC member or time member which comprises a resistor 22 having a variable resistance R and a capacitive element 24 having a capacitance C formed as a capacitor and arranged subsequent to the resistor 22 (in this case, the RC member is formed in such a way that it has a limit frequency which is lower than the data frequency f_{data}). The reference threshold signal detector 20 generates the adaptive reference threshold signal from the low-frequency baseband signal, which reference threshold signal is applied to the second input 34 of the threshold value circuit 30. By comparing the input signal at the first input 32 with the reference threshold signal at the second input 34, the threshold value circuit 30 supplies an output signal in a binary form whose value is determined by the fact whether the input signal is larger or smaller than the reference threshold signal. The threshold value circuit 30 thus acts as an A/D converter.

Since the data protocols are usually composed of single data packets in current radio data systems which, dependent on the system, are separated from each other by comparatively large temporal distances Tₐᵤₛ (overshoots and/or pauses and/or interruptions), the input signal naturally has such overshoots and/or pauses and/or interruptions. To prevent discharge of the capacitive element 24 during time intervals Tₐᵤₛ that are assignable to the overshoots and/or the pauses and/or the interruptions, the resistor 22 assumes, in the time intervals between the data packets, a high-ohmic state preventing a discharge of the capacitive element 24.

To be able to determine overshoots and/or pauses and/or interruptions in the input signal in an accurate and reliable way, a detector circuit 40 communicating with and arranged subsequent to the threshold value circuit 30 is provided. This detector circuit 40 comprises a slope detector unit 42 as well as at least a clock regaining unit 44 connected to the slope detector unit 42. By means of the slope detector unit 42, the clock regaining unit 44 regenerates, i.e. regains the data clock f_{data} from the digitized output signal leaving the output 36 of the threshold value circuit 30 and it can be recognized by means of this data clock f_{data} whether signal slopes occur or do not occur within temporally defined distances, whereupon the outgoing signal of a control circuit 50 communicating both with the detector circuit 40 and the reference threshold signal detector 20 either realizes the low-ohmic connection (“track” mode) or the high-ohmic connection (“hold” mode) between the low-frequency baseband signal and the capacitive element 24. To this end, the control circuit 50 comprises a decision unit communicating with the slope detector unit 42 and with the clock regaining unit 44, the respective outgoing signal from said decision unit setting the resistor 22 either to the high-ohmic state or to the low-ohmic state.

In the case of a so-called “valid” signal slope, i.e. when signal slopes are present within temporally defined distances (=time intervals that are not assignable to the overshoots and/or the pauses and/or the interruptions, meaning that there are no overshoots and/or pauses and/or interruptions of the incoming data stream) the resistor 22 assumes the low-ohmic state within which the threshold level of the adaptive reference threshold signal is adjustable at the current baseband level within the single data packets of the input signal.

In the “hold” mode (=high-ohmic state of the resistor 24), the adaptive threshold level of the reference threshold signal is “frozen” to some extent in that the signal from the control circuit 50 maintains the reference threshold signal applied to the threshold value circuit 30 in the time intervals Tₐᵤₛ that are assignable to the overshoots and/or the pauses and/or the interruptions at approximately the reference threshold value which the reference threshold signal has at the start of the overshoot and/or the pause and/or the interruption, which is the same as when no signal slopes occur within the defined time interval Tₐᵤₛ, which time interval Tₐᵤₛ should be chosen to be correspondingly small so as to prevent a strong discharge of the capacitive element 24; in the case of bi-phase coding, a time interval Tₐᵤₛ=2/f_{data} occurs, for example, where f_{data} is the above-defined data clock regenerated by the clock regaining unit 44.

With reference to the embodiment of the circuit arrangement 100 shown in FIG. 1, it is to be particularly noted that the control circuit 50 has both an externally and an internally triggerable reset function. After triggering the reset function, the resistor 22 assumes the low-ohmic state in which the capacitive element 24 can be advantageously charged to a given capacitance Cₜ after the reset function has been triggered so that it is not necessary to set an additional, fixed reference value at the second input 34 of the threshold value circuit 30, for example, by means of an additional resistor.

In summary, it can be stated that both pulse width distortions and losses of single bits at the start of a data packet can be prevented by the circuit arrangement 100 according to the present invention and shown in an embodiment in FIG. 1. Consequently, correct output signals are present at the digital data output of the receiver at an earlier stage so that the circuit arrangement 100 is inherent in an enhanced security against failures.

After the adaptive reference threshold signal has first been fixed, digital noise at the digital data output can be avoided so that one or more controllers connected to the receiver have a smaller interrupt load and the load of the controller as well as the bus load of possibly connected bus systems are also smaller.

Finally it should be noted that the circuit arrangement 100 shown by way of example in FIG. 1 has a backup function in the case of an external disturbance. For example, the level of the reference threshold signal may be inadmissibly raised when there are strong external in-band interferences in the “track” mode so that a regular data reception is no longer possible because the level of the useful signal in the baseband would be far below the actual faulty reference threshold signal value. For these unwanted cases, which cannot be avoided with absolute certainty, the circuit arrangement 100 is implemented in so far as the “hold” mode can be left by means of a self-triggered reset after a predefined time interval to be selected in dependence upon the transmission protocol used.

The circuit arrangement 100 and particularly the control circuit 50 can react flexibly to different protocols, in-band interferences or the like—if required, with a reset while the essential basis of the decision process in the control circuit 50 is the data clock f_{data} regained from the digitized output signal.

### LIST OF REFERENCE SIGNS

100 circuit arrangement

10 filter stage

20 reference threshold signal detector

22 resistor with variable resistance R

24 capacitive element with capacitance C

30 threshold value circuit

32 first input of the threshold value circuit 30

34 second input of the threshold value circuit 30

36 out put of the threshold value circuit 30

40 detector circuit

42 slope detector unit

44 clock regaining unit

50 control circuit

C capacitance of the capacitive element 24

f_{data} data frequency=data clock

R variable resistance of the resistor 22

Tₐᵤₛ time interval detected by the detector circuit 40 and assignable to the overshoots and/or the pauses and/or the interruptions

1. A circuit arrangement for converting a preferably analog input signal from at least a receiver, particularly at least a UHF or VHF receiver, into a digital output signal, said circuit arrangement (100) comprising:
at least one threshold value circuit (30) having a first input (32) for receiving the input signal;
a second input (34) for receiving a reference threshold signal generated by at least one reference threshold signal detector (20); and an output (36),
the digital output signal being formed in the threshold value circuit (30) by comparing the input signal at the first input (32) with the reference threshold signal at the second input (34);
at least one detector circuit (40) arranged subsequent to and communicating with the threshold value circuit (30) for detecting overshoots and/or pauses and/or interruptions in the input signal; and
at least one control circuit (50) communicating with the detector circuit (40) and the reference threshold signal detector (20), the output signal of said control circuit ensuring that the reference threshold signal applied to the threshold value circuit (30) during time intervals (Tₐᵤₛ) that are assignable to the overshoots and/or the pauses and/or the interruptions detected by the detector circuit (40) is maintained at approximately the reference threshold value comprising the reference threshold signal at the start of the overshoot and/or the pause and/or the interruption,
characterized in that
the reference threshold signal detector (20) forms the reference threshold signal from the input signal and comprises at least a resistor (22) having a variable resistance value (R) and at least a capacitive element (24) having a capacitance (C) arranged subsequent to the resistor (22), and in that
the resistor (22) assumes a high-ohmic state preventing a discharge of the capacitive element (24) during the time intervals (Tₐᵤₛ) that are assignable to the overshoots and/or the pauses and/or the interruptions, and a low-ohmic state during the time intervals that are not assignable to the overshoots and/or the pauses and/or the interruptions.

2. A circuit arrangement as claimed in claim 1, characterized in that the input signal is present in the form of a low-frequency analog baseband signal converted in the receiver.

3. A circuit arrangement as claimed in claim 1 or 2, characterized in that the first input (32) of the threshold value circuit (30) is preceded by at least a filter stage (10).

4. A circuit arrangement as claimed in any one of claims 1 to 3, characterized in that the threshold level of the reference threshold signal adapts to the level of the input signal in the low-ohmic state of the resistor (22).

5. A circuit arrangement as claimed in any one of claims 1 to 4, characterized in that the threshold value circuit (30) is constituted by a comparator whose first input (32) is positive and whose second input (34) is negative.

6. A circuit arrangement as claimed in any one of claims 1 to 5, characterized in that the detector circuit (40) comprises at least a slope detector unit (42) and at least a clock regaining unit (44) connected to the slope detector unit (42), and in that the detector circuit (40) regenerates the data clock (f_{data}) from the digital output signal.

7. A circuit arrangement as claimed in claim 6, characterized in that the control circuit (50) comprises at least a decision unit connected to the slope detector unit (42) and the clock regaining unit (44), whose respective outgoing signals change the resistor (22) either to the high-ohmic state or to the low-ohmic state.

8. A circuit arrangement as claimed in any one of claims 1 to 7, characterized in that the control circuit (50) has an externally and/or internally triggerable reset function.

9. A circuit arrangement as claimed in claim 8, characterized in that, after triggering the reset function of the control circuit (50), the resistor (22) assumes the low-ohmic state.

10. A circuit arrangement as claimed in claim 8 or 9, characterized in that, after triggering the reset function of the control circuit (50), the capacitive element (24) is chargeable to a given capacitance (Cₜ).

11. A circuit arrangement as claimed in any one of claims 1 to 10, characterized in that the capacitive element (24) is constituted at least as a capacitor.

12. A circuit arrangement as claimed in any one of claims 1 to 11, characterized in that an additional, fixed reference value is adjustable at the second input (34) of the threshold value circuit (30), particularly by means of an additional resistor.

13. A receiver, particularly a UHF or VHF receiver, comprising at least a subsequent circuit arrangement (100) as claimed in any one of claims 1 to 12.
